(19) United States
(12) Patent Application Publication
(10) Pub. No.: US 2026/0121067 A1
(43) Pub. Date: Apr. 30, 2026

(54) COATING FOR ELECTRODE ACTIVE MATERIALS, ELECTRODES, AND ELECTROCHEMICAL CELLS THEREOF

(71) Applicant: Solid Power Operating, Inc., Louisville, CO (US)

(72) Inventors: Megan M. WEBSTER, Denver, CO (US); Alexandra BOTHWELL, Boulder, CO (US); Ayana S. WEST, Thornton, CO (US); Jason E. ROBERTS, Denver, CO (US)

(21) Appl. No.: 19/376,441

(22) Filed: Oct. 31, 2025

Related U.S. Application Data
(60) Provisional application No. 63/714,739, filed on Oct. 31, 2024.

(51) Int. Cl. H01M 4/62; C01G 53/502; H01M 4/02; H01M 4/36; H01M 4/505; H01M 4/525; H01M 10/052; H01M 10/0562; H01M 50/434

(52) U.S. Cl. CPC H01M 4/628; C01G 53/502; H01M 4/366; H01M 4/505; H01M 4/525; H01M 10/052; H01M 10/0562; H01M 50/434; C01P 2004/03; C01P 2004/80; C01P 2006/12; C01P 2006/40; H01M 2004/021; H01M 2004/028; H01M 2300/0068

(57) ABSTRACT

Coated cathode active materials include a cathode active material that is coated by a hydroxide-containing material, such as a metal hydroxide. The coated cathode active materials may be incorporated into electrochemical cells, including solid-state batteries. Electrochemical cells including the coated cathode active materials have improved capacity retention as compared to electrochemical cells including un-coated cathode active materials.

### CROSS-REFERENCE TO RELATED APPLICATION

This application is related to and claims priority under 35 U.S.C. § 119 from U.S. Provisional Application No. 63/714,739 filed Oct. 31, 2024, titled “Coating for Electrode Active Material, Electrodes, and Electrochemical Cells Thereof,” the entire contents of which are fully incorporated by reference herein for all purposes.

### FIELD OF THE DISCLOSURE

The present disclosure is directed toward materials used in the electrodes of electrochemical cells, including solid-state electrochemical cells, and processes of making the same. Therefore, some aspects of the disclosure relate to the fields of batteries, including solid-state batteries, electronics, chemistry, and materials science.

### BACKGROUND AND INTRODUCTION

Battery technology has advanced rapidly over the last decade and the desires for batteries with increased charging speed, power density, energy density, and/or cycle life are at an all-time high. One of the major factors that drives these desired characteristics is the type and amount of cathode active material (CAM) that is contained within the electrochemical battery cell. A specific type of cathode active material that has captured the attention of a number of industries is the material known as nickel-manganese-cobalt (NMC). This material and its variants, when incorporated into a cathode layer, produce electrochemical cells with exceptionally high energy densities.

Unfortunately, though these NMC materials operate well in standard Lithium-Ion batteries which use liquid electrolytes, challenges arise when paired with solid state electrolytes, specifically sulfide based solid electrolytes. When an NMC material comes into contact with a sulfide based solid electrolyte material, the NMC material reacts to form metal sulfide degradation products. This reaction causes the desirable electrochemical properties to dramatically plumet. To prevent this degradation, others have resorted to applying a ceramic coating to surfaces of the NMC material where the ceramic coating material provides a stable barrier that separates the NMC material from the sulfide solid electrolytes. However, most conventional materials used to coat the NMC are expensive, use expensive coating techniques, have poor adhesion to the surface of the NMC material, and/or provide poor electrochemical stability. Accordingly, there is a need for methods and materials which can be used to increase the stability of NMC CAMs in an economic and efficient fashion, among other things.

It is with these observations in mind, among others, that aspects of the present disclosure were conceived.

### SUMMARY

Provided herein are coated cathode active materials for use in electrochemical cells including solid-state batteries. The coated cathode active materials generally include a cathode active material having a surface; and a coating layer disposed on the surface of the cathode active material, wherein the surface layer comprises a hydroxide material. In some embodiments, the cathode active material comprises nickel, manganese, cobalt, aluminum, oxygen, lithium, or a combination thereof. In some embodiments, the cathode active material comprises a NMC material represented by the formula Li(NiₐCo_{b}Mn_{c})O₂, wherein 0<a<1, 0<b<1, 0<c<1, and a+b+c=1. In some embodiments, the cathode active material comprises: LiCoO₂; LiNiO₂; LiMnO₂; LiMn₂O₄; LiNi_{1-Y}Co_{Y}O₂; LiCo_{1-Y}Mn_{Y}O₂; LiNi_{1-Y}Mn_{Y}O₂, wherein 0≤Y<1; Li(NiₐCo_{b}Mn_{c})O₄, wherein 0<a<2, 0<b<2, 0<c<2, and a+b+c=2; LiMn_{2-Z}Ni_{Z}O₄; LiMn_{2-Z}Co_{Z}O₄, wherein 0<Z<2; LiCoPO₄; Li(NiₐCo_{b}Al_{c})O₂, wherein 0<a<1, 0<b<1, 0<c<1, and a+b+c=1; or any combination thereof. In some embodiments, the hydroxide material comprises one or more of LiOH, NaOH, KOH, Ca(OH)₂, or Mg(OH)₂. In some embodiments, the coating layer has plate-like morphology. In some aspects, the plate-like morphology is defined by plate structures have a width from about 25 nm to about 500 nm. In some aspects, the coating layer comprises a hydroxide material having a plate-like morphology where the plates have a thickness from about 5 nm to about 100 nm. In some embodiments, the coating layer has a porosity from about 1% to about 20%. In some embodiments, the coating layer has a thickness from about 100 nm to about 2 μm. In some embodiments, about 5% to about 50% of the surface of the cathode active material is covered by the coating layer. In some embodiments, the cathode active material comprises a native coating comprising Li, Zr, Al, Nb, Ti, carbon, or any combination thereof. In some aspects, the native coating comprises Al₂O₃, ZrO₂, TiO₂, Nb₂O₅, LiNbO₃, LiAlO₂, Li₂ZrO₃, or any combination thereof. In some aspects, the native coating has a thickness from about 50 nm to about 5 μm. In some further aspects, the entire surface of the cathode active material particle is covered by the native coating, such that the first coating is interposed between the surface of the cathode active material and the coating layer.

Further provided herein are electrochemical cells that include the coated cathode active materials provided herein. The electrochemical cells include a cathode current collector, a cathode layer, a separator layer, an anode layer, and an anode current collector, wherein the cathode layer comprises a coated cathode active material comprising a cathode active material having a surface; and a coating layer disposed on the surface of the cathode active material, wherein the surface layer comprises a hydroxide material. In some aspects, the cathode active material comprises Li(NiₐCo_{b}Mn_{c})O₂, wherein 0<a<1, 0<b<1, 0<c<1, and a+b+c=1. In some embodiments, the separator layer comprises a sulfide solid electrolyte material. In some aspects, the sulfide solid electrolyte material comprises an argyrodite material. In some embodiments, the anode layer comprises Li, Li alloy, Si, Si alloy, carbon, or any combination thereof.

Further provided herein are methods of making the coated cathode active materials provided herein. The methods generally include combining a metal compound and a solvent to form a solution; adding a cathode active material to the solution to form a mixture; removing the solvent to produce the coated cathode active material. In some embodiments, the metal compound comprises Li, Na, K, Ca, or Mg. In some embodiments, the solvent comprises an alcohol. In some embodiments, the cathode active material comprises Li(NiₐCo_{b}Mn_{c})O₂, wherein 0<a<1, 0<b<1, 0<c<1, and a+b+c=1. In some embodiments, the method further includes adding a hydrogen-containing compound to the mixture prior to removing the solvent. In some aspects, the hydrogen-containing compound comprises H₂O or H₂O₂. In some embodiments, a ratio of the hydrogen-containing compound to the metal compound is from 1:10 to 1:100. In some embodiments, the method further includes heat treating the coated cathode active material. In some embodiments, the metal compound comprises a metal hydroxide. In some aspects, the metal compound comprises lithium hydroxide.

### BRIEF DESCRIPTION OF FIGURES

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic cross-sectional view of an example of uncoated and coated cathode material, in accordance with an embodiment.

FIG. 2A is a flow chart of a process for growing a lithium carbonate layer on a cathode material and using the resultant material in an electrochemical cell, in accordance with an embodiment.

FIG. 2B is a flow chart of a process for growing a lithium carbonate layer on a cathode material and using the resultant material in an electrochemical cell, in accordance with an embodiment.

FIG. 3 is a schematic cross-sectional view of an example of an electrochemical cell that includes the coated cathode active material of the present disclosure.

FIG. 4 is a plot demonstrating the difference between a coated cathode material and an uncoated cathode material regarding performance in an electrochemical cell, in accordance with an embodiment.

FIG. 5A is a Scanning Electron Microscope (SEM) image of a coated cathode active material particle produced in Example 1.

FIG. 5B is a zoomed-in portion of the SEM image of the coated cathode active material shown in FIG. 5A.

FIG. 5C is a schematic cross-section of a plate structure formed in the hydroxide-containing layer of the coated cathode active material of FIG. 5A.

FIG. 6 is a Scanning Electron Microscope (SEM) image of a coated cathode active material particle produced in Example 2.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

Provided herein are electrode active materials that include a coating layer that enhances the electrochemical stability of the electrode active material and provides for a solid-state electrochemical cell with increased cycle life and capacity retention. The coating layer acts as a barrier and stabilizing agent, which aids in reducing deleterious chemical reactions between the electrode active material and any solid electrolyte material that may be in contact with the electrode active material. These reactions normally occur during cell cycling and, as such, the coated electrode active material described herein is especially useful in, for example, cathode layers that include cathode active materials such as NMC, which may otherwise react with sulfide-based solid electrolyte materials.

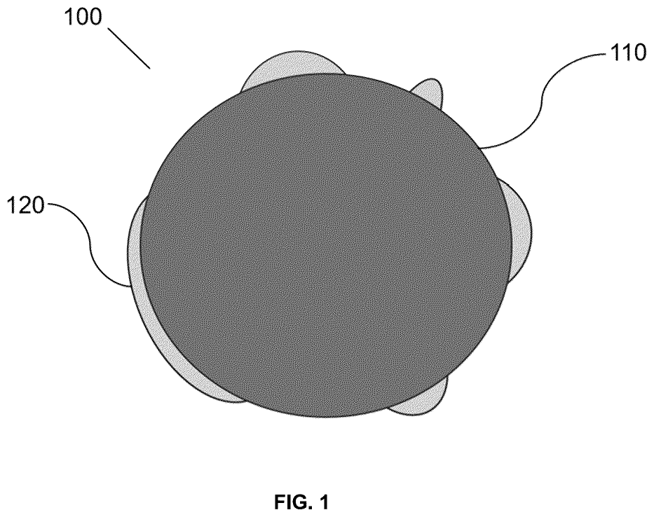

FIG. 1 is a schematic cross-sectional view of an example of a coated cathode active material 100. The cathode active material 110 may be, for example, a particle of NMC (nickel-manganese-cobalt) material ranging in size from about 1 μm to about 20 μm diameter. Generally, NMC is stoichiometrically in the form of LiNiₐMn_{b}Co_{c}O₂, where 0<a<1, 0<b<1, 0<c<1, and a+b+c=1. The cathode active material may include NMC 111 (LiNi_{0.33}Mn_{0.33}Co_{0.33}O₂), NMC 433 (LiNi_{0.4}Mn_{0.3}CO_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.3}Mn_{0.1}CO_{0.1}O₂), NMC 851005 (LiNi_{0.85}Mn_{0.05}Co_{0.1}O₂), or any combination thereof.

In some embodiments, the cathode active material 110 may include lithium, manganese, oxygen, cobalt, aluminum, iron, zirconia, tungsten, vanadium, titanium, molybdenum, or any combination thereof.

In another embodiment, the cathode active material 110 may comprise a coated or uncoated metal oxide, such as but not limited to LiNiO₂, LiNi_{1-Y}Co_{Y}O₂ (where 0≤Y<1), LiNi_{1-Y}Mn_{Y}O₂ (where 0≤Y<1), Li(NiₐCo_{b}Mn_{c})O₄ (where 0<a<2, 0<b<2, 0<c<2, a+b+c=2), LiMn_{2-Z}Ni_{Z}O₄ (where 0<Z<2), Li(NiₐCo_{b}Al_{c})O₂ (where 0<a<1, 0<b<1, 0<c<1, a+b+c=1), or any combination thereof.

In yet another embodiment, the cathode active material 110 may comprise a coated or uncoated metal oxide, such as but not limited to V₂O₅, V₆O₁₃, MoO₃, LiCoO₂, LiMnO₂, LiMn₂O₄, LiCo_{1-Y}Mn_{Y}O₂ (where 0≤Y<1), LiMn_{2-Z}Co_{Z}O₄ (0<Z<2), LiCoPO₄, LiFePO₄, CuO, or any combination thereof.

In yet a further embodiment, the cathode active material 110 may comprise one or more of a coated or uncoated metal sulfide such as but not limited to titanium sulfide (TiS₂), molybdenum sulfide (MoS₂), iron sulfide (FeS, FeS₂), copper sulfide (CuS), nickel sulfide (Ni₃S₂) and lithium sulfide (Li₂S), or combination thereof.

The cathode active material 110 has a hydroxide-containing layer 120 (also referred to herein as a “coating layer”) covering at least part of the surface of the cathode active material 110. The hydroxide-containing layer 120 may include a metal hydroxide, including lithium hydroxide, sodium hydroxide, potassium hydroxide, calcium hydroxide, magnesium hydroxide, titanium hydroxide, zirconium hydroxide, manganese hydroxide, nickel hydroxide, iron hydroxide, aluminum hydroxide, tin hydroxide, niobium hydroxide, tungsten hydroxide, or any combination thereof. In some embodiments, the hydroxide-containing layer 120 may include lithium hydroxide, sodium hydroxide, potassium hydroxide, or any combination thereof. In some aspects, low-grade lithium hydroxide may contain one or more of the other metal hydroxides described above.

In some embodiments, the hydroxide-containing layer 120 may comprise lithium hydroxide in the amount of in excess of 50%. In some embodiments, the amount of lithium hydroxide in the hydroxide-containing layer 120 exceeds 60%, or exceeds 70%, or 80%, or 90%, or 95%, or 99%.

In some embodiments, the hydroxide-containing layer 120 may cover from about 5% to about 100% of the surface of the cathode active material 110. For example, the hydroxide-containing layer 120 may cover from about 5% to about 20%, about 5% to about 40%, about 5% to about 60%, about 5% to about 80%, about 5% to about 100%, about 20% to about 100%, about 40% to about 100%, about 60% to about 100%, about 80% to about 100%, about 20% to about 80%, or about 40% to about 60% of the surface of the cathode active material 110. As another example, the hydroxide-containing layer 120 may cover about 5%, 10%, 15%, 20%, 25%, 30%, 35%, 40%, 45%, 50%, 55%, 60%, 65%, 70%, 75%, 80%, 85%, 90%, 95%, or about 100% of the surface of the cathode active material 110.

In some embodiments, the hydroxide-containing layer 120 may cover from about 5% to about 50% of the surface of the cathode active material 110. For example, the hydroxide-containing layer 120 may cover from about 5% to about 10%, about 5% to about 20%, about 5% to about 30%, about 5% to about 40%, about 5% to about 50%, about 10% to about 50%, about 20% to about 50%, about 30% to about 50%, about 40% to about 50%, about 10% to about 40%, or about 20% to about 30% of the surface of the cathode active material 110.

The hydroxide-containing layer 120 may further comprise lithium ethoxide, lithium oxide, lithium carbonate, or any combination thereof.

The hydroxide-containing layer 120 may have a thickness of up to 2 μm. For example, the hydroxide-containing layer 120 may have a thickness of up to 2 μm, up to 1.75 microns, up to 1.5 μm, up to 1.25 μm, up to 1 μm, up to 0.75 μm, or up to 0.5 μm. Stated another way, the hydroxide-containing layer may have a thickness from greater than 0 μm to about 0.25 μm, greater than 0 μm to about 0.5 μm, greater than 0 μm to about 0.75 μm, greater than 0 μm to about 1 μm, greater than 0 μm to about 1.25 μm, greater than 0 μm to about 1.5 μm, greater than 0 μm to about 1.75 μm, greater than 0 μm to about 2 μm, about 0.25 μm to about 2 μm, about 0.5 μm to about 2 μm, about 0.75 μm to about 2 μm, about 1 μm to about 2 μm, about 1.25 μm to about 2 μm, about 1.5 μm to about 2 μm, or about 1.75 μm to about 2 μm.

In some embodiments, the thickness of this hydroxide-containing layer may be from about 1 nm to about 1 μm; for example, the thickness of the hydroxide-containing layer may be from about 1 nm to about 5 nm, about 1 nm to about 10 nm, about 1 nm to about 20 nm, about 1 nm to about 50 nm, about 1 nm to about 100 nm, about 1 nm to about 250 nm, about 1 nm to about 500 nm, about 1 nm to about 750 nm, about 1 nm to about 1 μm, about 5 nm to about 1 μm, about 10 nm to about 1 μm, about 20 nm to about 1 μm, about 50 nm to about 1 μm, about 100 nm to about 1 μm, about 250 nm to about 1 μm, about 500 nm to about 1 μm, or about 750 nm to about 1 μm. In some embodiments, the thickness may be from about 5 nm to about 750 nm. In another embodiment, the thickness may be from about 10 nm to about 500 nm. In a further embodiment, the thickness may be from about 15 nm to about 250 nm. In yet another embodiment, the thickness may be from about 17 nm to about 100 nm. In another embodiment, the thickness may be from about 20 nm to about 50 nm.

The hydroxide-containing layer 120 and the cathode active material 110 may be present in the coated cathode active material 100 in a weight ratio from about 1:99 to about 10:90 (hydroxide-containing layer:cathode active material). For example, the hydroxide-containing layer 120 and the cathode active material 110 may be present in the coated cathode active material 100 in a weight ratio from about 1:99 to about 3:97, about 1:99 to about 5:95, about 1:99 to about 7:93, about 1:99 to about 9:91, about 1:99 to about 10:90, about 3:97 to about 10:90, about 5:95 to about 10:90, about 7:93 to about 10:90, about 9:91 to about 10:90, about 2:98 to about 8:92, or about 4:96 to about 6:94. As another example, the hydroxide-containing layer 120 and the cathode active material 110 may be present in the coated cathode active material 100 in a weight ratio of about 1:99, 2:98, 3:97, 4:96, 5:95, 6:94, 7:93, 8:92, 9:91, or about 10:90.

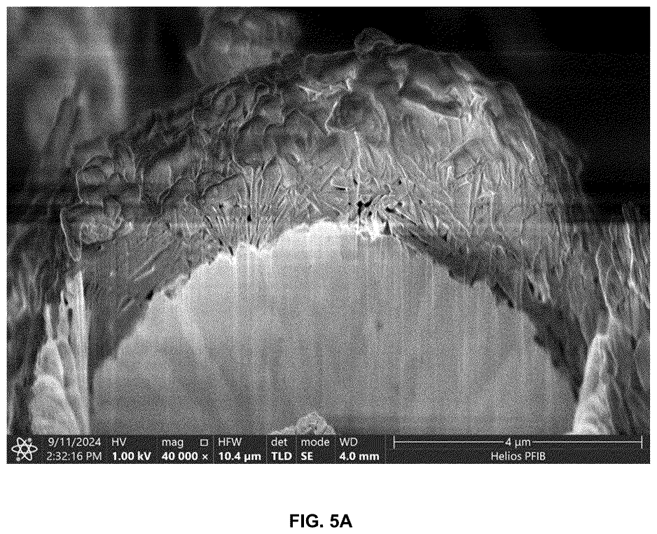

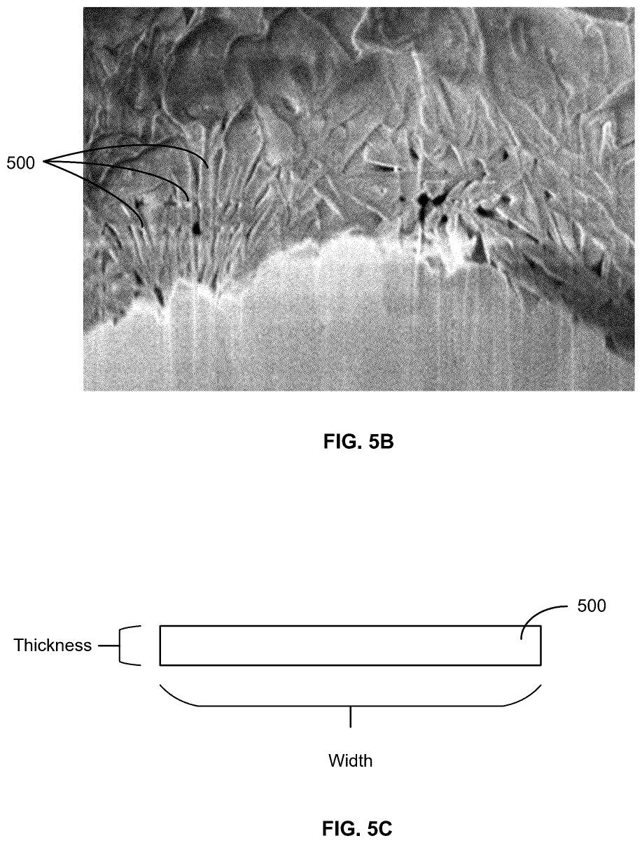

The hydroxide-containing layer 120 may have a plate-like morphology as shown in FIG. 5A and FIG. 5B, which is a zoomed-in view of a portion of the coated cathode material shown in FIG. 5A. This morphology may be defined by plate structures 500 being formed on the hydroxide-containing layer. A schematic drawing of one of the plate structures 500 is shown in FIG. 5C, defining the width and thickness of the plate structures 500. The plate structures 500 may have a width from about 25 nm to about 500 nm. For example, the plates may have a width from about 25 nm to about 100 nm, about 25 nm to about 200 nm, about 25 nm to about 300 nm, about 25 nm to about 400 nm, about 25 nm to about 500 nm, about 100 nm to about 500 nm, about 200 nm to about 500 nm, about 300 nm to about 500 nm, about 400 nm to about 500 nm, about 100 nm to about 400 nm, or about 100 nm to about 300 nm. As another example, the plates may have a width of about 25 nm, 50 nm, 75 nm, 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, or about 500 nm.

The plate structures 500 may have a thickness from about 5 nm to about 100 nm. For example, the plates may have a thickness from about 5 nm to about 20 nm, about 5 nm to about 40 nm, about 5 nm to about 60 nm, about 5 nm to about 80 nm, about 5 nm to about 100 nm, about 20 nm to about 100 nm, about 40 nm to about 100 nm, about 60 nm to about 100 nm, about 80 nm to about 100 nm, about 20 nm to about 80 nm, or about 40 nm to about 60 nm. As another example, the plates may have a thickness of about 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or about 100 nm.

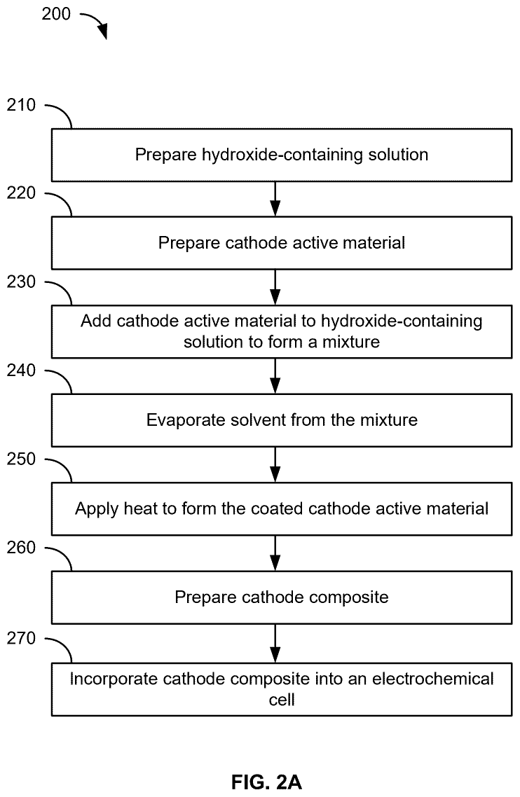

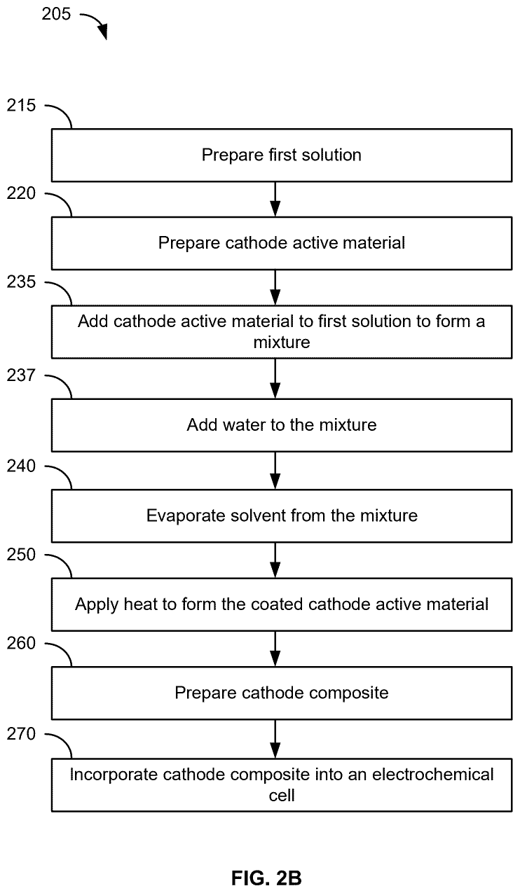

FIG. 2A is a flow chart of a process 200 for making the coated cathode active materials of the present disclosure, incorporating the coated cathode active material into a cathode composite, and integrating the cathode composite into an electrochemical cell.

Process 200 begins with step 210 wherein a hydroxide-containing solution is prepared. The solvent used to form the hydroxide-containing solution may comprise an alcohol such as methanol, ethanol, propanol, isopropyl alcohol, butanol, pentanol, hexanol, heptanol, or any combination thereof. The solvent may further comprise a hydrocarbon-based solvent such as heptane, hexane, octane, dodecane, benzene, toluene, xylene (including para-, meta-, and/or ortho-xylene), or any combination thereof.

To this solution, a hydroxide-containing material is added. The hydroxide-containing material may be any of the metal hydroxides described hereinabove. In some embodiments, the hydroxide-containing material includes lithium hydroxide.

The weight ratio of the hydroxide-containing material to solvent may be from about 1:25 to about 1:100. For example, the weight ratio of the hydroxide-containing material to solvent may be from about 1:25 to about 1:50, about 1:25 to about 1:75, about 1:25 to about 1:100, about 1:50 to about 1:100, about 1:75 to about 1:100, or about 1:50 to about 1:75. As another example, the weight ratio of the hydroxide-containing material to solvent may be about 1:25, 1:30, 1:35, 1:40, 1:45, 1:50, 1:55, 1:60, 1:65, 1:70, 1:75, 1:80, 1:85, 1:90, 1:95, or about 1:100.

As the solvent and the hydroxide-containing material contact, the lithium containing material may react with the solvent or may fully or partially dissolve. To encourage reaction or dissolution, the hydroxide-containing solution may be mixed or stirred. The hydroxide-containing solution may be mixed for 1 minute to 24 hours. The hydroxide-containing solution may be heated during step 210 to a temperature greater than the boiling point of one or more of the solvents used under reflux to aid with dissolution of the materials in the solution. For example, the temperature may be greater than 30° C. In another embodiment, the temperature may be greater than 40° C., greater than 50° C., greater than 60° C., greater than 70° C., greater than 80° C., greater than 90° C., greater than 100° C., or greater than 110° C.

Next, during step 220, the cathode active material is prepared for the coating process. Preparing the cathode active material may include milling and/or sieving the cathode active material to remove agglomerates. It should be noted that no special surface treatment, such as cleaning or rinsing, of the cathode active material may be required.

In some embodiments the cathode active material may have an existing coating on its surface known as a “native coating.” This native coating is separate and distinct from the hydroxide-containing layer added to the cathode active material. The native coating, when present, is interposed between the cathode active material surface and the hydroxide-containing layer.

The native coating may comprise aluminum, zirconium, niobium, lithium, titanium, carbon, or salts or oxides thereof. In some embodiments, the native coating may include Al₂O₃, ZrO₂, TiO₂, Nb₂O₅, LiNbO₃, LiAlO₂, Li₂ZrO₃, or any combination thereof.

The native coating may have a thickness from about 50 nm to about 5 μm. For example, the native coating may have a thickness from about 50 nm to about 100 nm, about 50 nm to about 500 nm, about 50 nm to about 1 μm, about 50 nm to about 5 μm, about 100 nm to about 5 μm, about 500 nm to about 5 μm, about 1 μm to about 5 μm, about 100 nm to about 1 μm, or about 500 nm to about 1 μm. As another example, the native coating may have a thickness of about 50 nm, 60 nm, 70 nm, 80 nm, 90 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1 μm, 1.5 μm, 2 μm, 2.5 μm, 3 μm, 3.5 μm, 4 μm, 4.5 μm, or about 5 μm.

Next, during step 230, the cathode active material is added to the hydroxide-containing solution to form a mixture. This mixture may be agitated for a period of time from about a minute to about 36 hours. The agitation may take the form of mixing, stirring, tumbling, milling, grinding, or a combination thereof.

In some embodiments, a hydrogen-containing compound may be added to the mixture during step 230. The hydrogen-containing compound may include water (H₂O) or hydrogen peroxide (H₂O₂). The amount of hydrogen-containing compound added may be up to about 5% by weight of the solvent in the solution. During and after this optional hydrogen-containing compound addition step, agitation may continue.

Once the materials are adequately mixed, the solvent(s) may be removed in step 240. The solvent may be removed by adjusting the pressure and temperature of the mixture such that the solvent evaporates.

In some embodiments, the pressure during step 240 may be increased or decreased to greater than 0 ATM to about 2 ATM; for example, the pressure may be from about 0.01 ATM to about 1 ATM, about 0.01 ATM to about 0.9 ATM, about 0.01 ATM to about 0.8 ATM, about 0.05 ATM to about 0.7 ATM, about 0.1 ATM to about 0.6 ATM, or about 0.2 ATM to about 0.5 ATM.

In some embodiments, the temperature applied during the solvent evaporating step may be adjusted to about 20° C. to about 120° C.; for example, the temperature may be from about 20° C. to about 40° C., about 20° C. to about 60° C., about 20° C. to about 80° C., about 20° C. to about 100° C., about 20° C. to about 120° C., about 40° C. to about 120° C., about 60° C. to about 120° C., about 80° C. to about 120° C., or about 100° C. to about 120° C.

The evaporation step 240 may take place over a period of time that may range from minutes to days. For example, the amount of time may be about 5 minutes, about 15 minutes, about 30 minutes, about 1 hour, about 2 hours, about 4 hours, about 8 hours, about 16 hours, about 24 hours, or about 48 hours.

After the desired period of time has elapsed, at least 50% by mass of the solvent may be removed. In some embodiments, at least 60% of the solvent may be removed. In yet another embodiment, at least 70%, or 80%, or 90%, or 95% or 99% of the solvent has been removed. Once the desired amount of solvent has been removed, a hydroxide-containing layer is formed on the surface of the cathode active material.

At this stage, the hydroxide-containing layer may have a porosity from about 10% to 50%. For example, the hydroxide-containing layer may have a porosity from about 10% to about 20%, about 10% to about 30%, about 10% to about 40%, about 10% to about 50%, about 20% to about 50%, about 30% to about 50%, about 40% to about 50%, about 20% to about 40%, about 20% to about 30%, or about 30% to about 40%. As another example, the hydroxide-containing layer may have a porosity of about 10%, 15%, 20%, 25%, 30%, 35%, 40%, 45%, or about 50%.

Once the desired amount of solvent has been removed, the material may be further heated in step 250.

The heat treatment may be conducted at a temperature from about 150° C. to about 500° C. For example, the temperature may be from about 150° C. to about 500° C., about 200° C. to about 500° C., about 250° C. to about 500° C., about 300° C. to about 500° C., or about 350° C. to about 500° C. As another example, the heat treatment may be conducted at a temperature of about 150° C., 175° C., 200° C., 225° C., 250° C., 275° C., 300° C., 325° C., 350° C., 375° C., 400° C., 425° C., 450° C., 475° C., or about 500° C.

In some embodiments, the heat treatment may be conducted for a period from minutes to days. For example, the amount of time may be about 5 minutes, about 15 minutes, about 30 minutes, about 1 hour, about 2 hours, about 4 hours, about 8 hours, about 16 hours, about 24 hours, or about 48 hours.

In some embodiments, the heat treatment may be conducted at a pressure of above 0 ATM to about 2 ATM; for example, the pressure may be from about 0.01 ATM to about 1 ATM, about 0.01 ATM to about 0.9 ATM, about 0.01 ATM to about 0.8 ATM, about 0.05 ATM to about 0.7 ATM, about 0.1 ATM to about 0.6 ATM, or about 0.2 ATM to about 0.5 ATM.

After the heating step 250, the hydroxide-containing layer may have a porosity from about 1% to 20%. For example, the hydroxide-containing layer may have a porosity from about 1% to about 5%, about 1% to about 10%, about 1% to about 15%, about 1% to about 20%, about 5% to about 20%, about 10% to about 20%, about 15% to about 20%, about 5% to about 15%, about 5% to about 10%, or about 10% to about 15%. As another example, the porosity may be about 1%, 2%, 3%, 4%, 5%, 6%, 7%, 8%, 9%, 10%, 11%, 12%, 13%, 14%, 15%, 16%, 17%, 18%, 19%, or about 20%.

The process may then proceed to step 260. To prepare a cathode active material composite containing the coated cathode active material, the coated cathode active material may be incorporated into a cathode slurry. The cathode slurry may comprise the coated cathode active material and a solvent. The cathode slurry may then be mixed or stirred to combine the coated cathode active material and the solvent.

The slurry may further comprise a binder. The binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may include an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), or mixtures thereof.

Preferably, the binder comprises a thermoplastic elastomer such as those comprising styrene and butadiene. For example, the binder may comprise styrene-butadiene-styrene copolymer (SBS), styrene-isoprene block copolymer (SIS), styrene-ethylene-butylene-styrene (SEBS), or combinations thereof.

In some embodiments, the binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

In embodiments wherein the cathode slurry comprises a high molecular weight binder and a low molecular weight binder, the high molecular weight binder and the low molecular weight binder may be present in a weight ratio from about 10:90 to about 90:10, such as from about 10:90 to about 20:80, about 10:90 to about 30:70, about 10:90 to about 40:60, about 10:90 to about 50:50, about 10:90 to about 60:40, about 10:90 to about 70:30, about 10:90 to about 80:20, about 10:90 to about 90:10, about 20:80 to about 90:10, about 30:70 to about 90:10, about 40:60 to about 90:10, about 50:50 to about 90:10, about 60:40 to about 90:10, about 70:30 to about 90:10, about 80:20 to about 90:10, about 20:80 to about 80:20, about 25:75 to about 75:25, or about 30:70 to about 70:30.

The binder may be present in the cathode slurry in an amount from about 1% to about 30% by weight of the slurry. For example, the binder may be present in the slurry in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the slurry.

The cathode slurry may further comprise a conductive additive where the conductive additive helps to evenly distribute the charge density throughout the cathode composite. The conductive additives may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

In some embodiments, the conductive additive may be present in the cathode slurry in an amount from about 0% to about 15% by weight of the cathode slurry. In some aspects, the conductive additive may be present in the slurry in an amount from about 0% to about 10%, or about 0% to about 5% by weight of the slurry. In some additional aspects, the conductive additive may be present in the slurry in an amount of about 0%, 1%, 2%, 3%, 4%, 5%, 6%, 7%, 8%, 9%, 10%, 11%, 12%, 13%, 14%, or about 15% by weight of the slurry. In an example embodiment, the conductive additive is present in the slurry in an amount from about 0% to about 5% by weight of the slurry.

In some embodiments, the average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In some examples, the conductive additive may have an average particle size of about 30 nm. The average particle size (e.g., Do) may be determined through any method known to those having ordinary skill in the art.

The slurry may further comprise a solid electrolyte material. The solid electrolyte material may comprise an oxide, oxysulfide, sulfide, halide, nitride, or any other solid electrolyte known in the art. In some preferred embodiments, the solid electrolyte material may comprise a sulfide solid electrolyte material, i.e., a solid electrolyte having at least one sulfur component. In some embodiments, the sulfide solid electrolyte material may comprise an argyrodite material having the chemical formula Li_{6-y}PS_{5-y}X_{y}, where X is a halogen or pseudohalogen, and 1≤y≤2. In some embodiments, the one or more solid electrolytes may comprise one or more material combinations such as Li₂S—P₂S₅, Li₂S—P₂S₅—LiI, Li₂S—P₂S₅—GeS₂, Li2_{S}-P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—Li, Li₂S—B₂S3, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(ß-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Ti, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In another embodiment, the solid electrolyte material may include Li₃PS₄, Li₄P₂S₆, Li₇P₃S₁₁, Li₁₀GeP₂S₁₂, Li₁₀SnP₂S₁₂. In a further embodiment, the solid electrolyte material may include Li₆PS₅Cl, Li₆PS₅Br, Li₆PS₅I or may be expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material may be expressed by the formula Li_{8-y-z}S_{9-y-z}X_{y}W_{z} (where “X” and “W” represents at least one halogen and/or at least one pseudo-halogen and where 0≤y≤1 and 0≤z≤1) and where the halogen may be one or more of F, C, Br, I, and the pseudo-halogen may be one or more of N, NH, NH₂, NO, NO₂, BF₄, BH₄, AlH₄, CN, and SCN.

The solid electrolyte material may be present in the slurry in an amount from greater than 0% to about 60% by weight of the slurry; for example, the solid electrolyte may be present in the slurry in an amount from greater than 0% to about 10% by weight, greater than 0% to about 20% by weight, greater than 0% to about 30% by weight, greater than 0% to about 40% by weight, greater than 0% to about 50% by weight, about 10% to about 60% by weight, about 20% to about 60% by weight, about 30% to about 60% by weight, about 40% to about 60% by weight, or about 50% to about 60% by weight of the slurry. In some aspects, the solid-state electrolyte material may be present in the slurry in an amount of about 5%, 10%, 15%, 20%, 25%, 30%, 35%, 40%, 45%, 50%, 55%, or 60% by weight of the slurry. In an example embodiment, the solid electrolyte material is present in the slurry in an amount from about 35% to about 45% by weight of the slurry.

The solid electrolyte material may have an average particle size from about 0.5 μm to about 50 μm, such as from about 0.5 μm to about 1 micron, about 0.5 μm to about 10 μm, about 0.5 μm to about 20 μm, about 0.5 μm to about 30 μm, about 0.5 μm to about 40 μm, about 0.5 μm to about 0.5 μm, about 1 μm to about 50 microns, about 10 μm to about 50 μm, about 20 μm to about 50 μm, about 30 μm to about 50 μm, or about 40 μm to about 50 μm.

The coated cathode active material may be present in the cathode slurry in an amount from about 30% to about 98% by weight of the slurry. In some aspects, the coated cathode active material may be present in the slurry in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the slurry.

In some embodiments, the slurry may further comprise a secondary cathode active material. The secondary cathode active material may include nickel-manganese-cobalt (“NMC”) which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}CO_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.3}Mn_{0.1}CO_{0.1}O₂) or a combination thereof. In another embodiment, the secondary cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}CO_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the secondary cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the secondary cathode active material may comprise elemental sulfur (S). In additional embodiments, the secondary cathode active material may comprise one or more of a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (Ill) fluoride (FeF₃), vanadium (Ill) fluoride (VF₃), cobalt (Ill) fluoride (CoF₃), chromium (Ill) fluoride (CrF₃), manganese (Ill) fluoride (MnF₃), aluminum fluoride (AlF₃), and zirconium (IV) fluoride (ZrF₄), or combinations thereof.

The cathode slurry may have a solids content from about 10% to less than 100%. For example, the slurry may have a solids content from about 10% to about 20%, about 10% to about 30%, about 10% to about 40%, about 10% to about 50%, about 10% to about 60%, about 10% to about 70%, about 10% to about 80%, about 10% to about 90%, about 10% to less than 100%, about 20% to less than 100%, about 30% to less than 100%, about 40% to less than 100%, about 50% to less than 100%, about 60% to less than 100%, about 70% to less than 100%, about 80% to less than 100%, about 90% to less than 100%, about 50% to about 90%, about 60% to about 90%, or about 70% to about 90%.

The cathode slurry may have a viscosity from about 20 cP to about 3000 cP measured at a shear rate of about 100 s⁻¹. For example, the cathode slurry may have a viscosity form about 20 cP to about 100 cP, about 20 cP to about 500 cP, about 20 cP to about 1000 cP, about 20 cP to about 1500 cP, about 20 cP to about 2000 cP, about 20 cP to about 2500 cP, about 20 cP to about 3000 cP, about 100 cP to about 3000 cP, about 500 cP to about 3000 cP, about 1000 cP to about 3000 cP, about 1500 cP to about 3000 cP, about 2000 cP to about 3000 cP, or about 2500 cP to about 3000 cP. In some embodiments, the cathode slurry may have a viscosity of about 20 cP, 50 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, 1000 cP, 1100 cP, 1200 cP, 1300 cP, 1400 cP, 1500 cP, 1600 cP, 1700 cP, 1800 cP, 1900 cP, 2000 cP, 2100 cP, 2200 cP, 2300 cP, 2400 cP, 2500 cP, 2600 cP, 2700 cP, 2800 cP, 2900 cP, or about 3000 cP measured at a shear rate of about 100 s⁻¹.

The solvent used in the cathode slurry may be one or more of an ester solvent or a hydrocarbon solvent. All of the materials contained in the cathode slurry may be mixed to form a homogeneous slurry. Methods of combining and mixing are generally known to those having ordinary skill in the art.

The hydrocarbon solvents may include alkanes, alkenes, alkynes, or any combination thereof. The hydrocarbon solvent may be linear, branched, or may contain one or more cycles. In some examples, the hydrocarbon solvent includes one or more C₄-C₄₀ hydrocarbons, such as C₄-C₂₀ hydrocarbons, C₄-C₁₅ hydrocarbons, or C₃-C₁₂ hydrocarbons. In some embodiments, the hydrocarbon solvent includes isoparaffins. In some embodiments, the hydrocarbon solvent may include butane, pentane, hexane, heptane, octane, nonane, decane, undecane, dodecane, any isomers thereof, or any combination thereof. In a preferred embodiment, the hydrocarbon solvent may include hexane, heptane, octane, nonane, decane, isoparaffins, any isomers thereof, or any combination thereof.

The ester solvent may include any ester solvent known to those having ordinary skill in the art. For example, the ester solvent may include butyl butyrate, isobutyl isobutyrate, methyl propionate, ethyl propionate, propyl propionate, butyl propionate, amyl propionate, methyl acetate, ethyl acetate, propyl acetate, butyl acetate, or any combination thereof.

The cathode slurry may then be coated onto a surface. The surface may comprise a carrier foil, a current collector, a dried electrochemical cell layer, or another surface. The coating may be accomplished by pouring the slurry onto a surface via gravity or by pumping the slurry onto the surface. The process may take place in ambient conditions or may take place in an inert atmosphere such as nitrogen or argon. In some embodiments, the process may be conducted in an atmosphere comprising air and moisture. In other embodiments, the process may be conducted in an atmosphere comprising air and substantially no moisture (i.e., less than 1% humidity).

The slurry may be coated onto the surface at ambient temperature and pressure. In some aspects, the slurry may be coated onto the surface at a temperature up to the boiling point of the solvent system used in the slurry, or the slurry may be coated at cooler temperatures to limit vaporization of the solvent.

Once coated the solvent may be removed from the cathode slurry by drying the coated slurry to form a cathode composite. The drying may occur at a temperature from about 15° C. to about 300° C. For example, the drying may occur at a temperature from about 15° C. to about 30° C., about 15° C. to about 50° C., about 15° C. to about 100° C., about 15° C. to about 150° C., about 15° C. to about 200° C., about 15° C. to about 250° C., about 15° C. to about 300° C., about 30° C. to about 300° C., about 50° C. to about 300° C., about 100° C. to about 300° C., about 150° C. to about 300° C., about 200° C. to about 300° C., or about 250° C. to about 300° C. In some embodiments, the drying may occur at a temperature of about 15° C., 20° C., 25° C., 30° C., 35° C., 40° C., 45° C., 50° C., 60° C., 70° C., 80° C., 90° C., 100° C., 125° C., 150° C., 175° C., 200° C., 225° C., 250° C., 275° C., or about 300° C.

After the drying is completed, the amount of solvent left in the cathode composite may range from about 0.01% to 0% by weight of the cathode composite.

If there is solvent remaining in the cathode composite, the electrochemical performance of an electrochemical cell containing the cathode composite may be negatively affected.

Further processing may include densifying the cathode composite. The cathode composite may be densified through densification processes known to those having ordinary skill in the art, such as calendaring, linear densification, compaction, or compression. In preferred embodiments, the densifying may be accomplished via calendaring, forming a densified cathode composite that may be incorporated into an electrochemical cell.

The densified cathode composite may have a density from about 50% to about 99% of the theoretical density of the cathode composite. The theoretical density is defined as the maximum density of the composition that could be achieved assuming there are no voids or contaminants. The density may be from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99% of the theoretical density of the densified cathode composite.

The densified cathode composite may have a porosity from about 1% to about 70%. For example, the densified cathode composite may have a porosity from about 1% to about 10%, about 1% to about 20%, about 1% to about 30%, about 1% to about 40%, about 1% to about 50%, about 1% to about 60%, about 1% to about 70%, about 10% to about 70%, about 20% to about 70%, about 30% to about 70%, about 40% to about 70%, about 50% to about 70%, or about 60% to about 70%. The porosity of the densified cathode composite may be measured through techniques known in the art, such as through SEM imaging, TEM imaging, FIB-SEM imaging, confocal microscopy, gas adsorption, mercury porosimetry, helium pycnometry, or other methods known in the art.

FIG. 2B shows an alternate process 205 for forming the coated cathode active materials of the present disclosure. The process begins at step 215 preparing a first solution that includes one or more solvents and a metal compound. The metal compound may include an alkali metal compound or an alkali earth metal compound. In some embodiments, the metal compound includes lithium, sodium, potassium, calcium, or magnesium.

The one or more solvents may be any of the solvents described above with respect to step 210 of process 200. The metal compound may include a metal, a metal alloy, a metal ethoxide, a metal ethoxide, a metal nitride, or a combination thereof. The metal may include lithium, sodium, potassium, calcium, magnesium, titanium, zirconium, manganese, nickel, iron, aluminum, tin, niobium, tungsten, or any combination thereof.

In some embodiments, the metal compound may include lithium hydroxide, lithium metal, lithium ethoxide, lithium oxide, or lithium nitride. In another embodiment, the metal compound may include sodium metal, potassium metal, calcium metal, magnesium metal, lithium metal alloys, sodium hydroxide, potassium hydroxide, or any combination thereof.

The process 205 then proceeds as described above with respect to step 220. Once the cathode active material is prepared at step 220, the process 205 proceeds to step 235, where the cathode active material is added to the first solution to form a mixture. This mixture may be agitated for a period of time from about a minute to about 36 hours. The agitation may take the form of mixing, stirring, tumbling, milling, grinding, or a combination thereof.

In some embodiments, a hydrogen-containing compound may be added to the mixture during step 237. The hydrogen-containing compound may include water (H₂O) or hydrogen peroxide (H₂O₂). Adding hydrogen-containing compound to the mixture may cause a reaction with the metal compound to produce a hydroxide if the metal compound is not already a hydroxide. By way of example, when the metal compound includes lithium metal and the solvent includes ethanol, lithium ethoxide may form in the mixture. When the hydrogen-containing compound is added, the lithium ethoxide and the hydrogen-containing compound may react to produce lithium hydroxide.

The amount of hydrogen-containing compound added may be up to about 5% by weight of the solvent. For example, the amount of hydrogen-containing compound added may be up to about 5%, up to about 4%, up to about 3%, up to about 2%, or up to about 1% by weight of the solvent. As another example, the amount of hydrogen-containing compound added to the mixture may be from about 1% to about 5% by weight of the solvent, such as from about 1% to about 2%, about 1% to about 3%, about 1% to about 4%, about 1% to about 5%, about 2% to about 5%, about 3% to about 5%, about 4% to about 5%, or about 2% to about 4% by weight of the solvent. As yet another example, the amount of hydrogen-containing compound added may be about 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, or about 4%.

The hydrogen-containing compound may be added to the mixture in an amount having a weight ratio to the metal compound from about 1:10 to about 1:100 (hydrogen-containing compound:metal compound). For example, the hydrogen-containing compound may be added to the mixture in an amount having a weight ratio to the metal compound from about 1:10 to about 1:20, about 1:10 to about 1:40, about 1:10 to about 1:60, about 1:10 to about 1:80, about 1:10 to about 1:100, about 1:20 to about 1:100, about 1:40 to about 1:100, about 1:60 to about 1:100, about 1:80 to about 1:100, about 1:20 to about 1:80, or about 1:40 to about 1:60. As another example, hydrogen-containing compound may be added to the mixture in an amount having a weight ratio to the metal compound of about 1:10, 1:15, 1:20, 1:25, 1:30, 1:35, 1:40, 1:45, 1:50, 1:55, 1:60, 1:65, 1:70, 1:75, 1:80, 1:85, 1:90, 1:95, or about 1:100.

Steps 240, 250, 260, and 270 may then proceed as described above with respect to process 200.

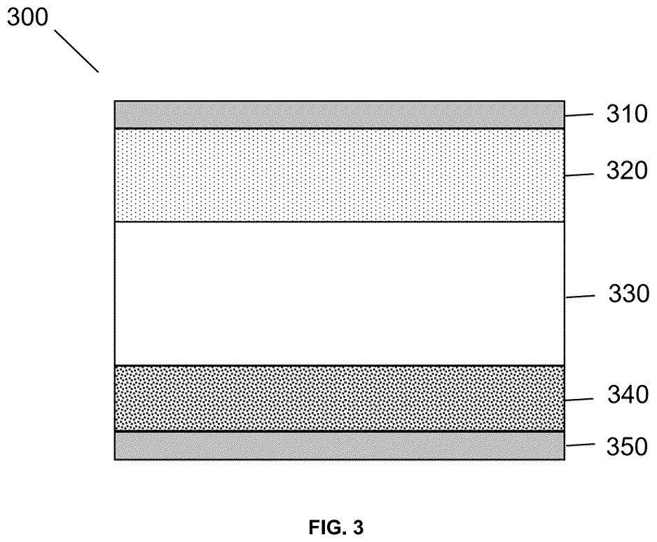

FIG. 3 is a schematic cross-sectional view of a solid-state electrochemical cell 300 that includes the coated cathode material described herein. The solid-state electrochemical cell 300 includes a positive electrode current collector 310, a positive electrode active material composite 320 (i.e., the cathode composite described herein, also referred to as a cathode layer), a separator 330 (also referred to as a solid electrolyte layer), a negative electrode active material composite 340 (also referred to as an anode layer), and a negative electrode current collector 350. The positive electrode active material composite 320 may be positioned between the positive electrode current collector 310 and the separator 330. The negative electrode active material composite 340 may be positioned between the negative electrode current collector 350 and the separator 330. The positive electrode current collector 310 electrically contacts composite positive electrode active material composite 320, and the negative electrode current collector 350 electrically contacts the negative electrode active material composite 340.

The positive electrode current collector 310 may be formed from materials including, but not limited to, aluminum (AI), nickel (Ni), titanium (Ti), stainless steel, magnesium (Mg), iron (Fe), zinc (Zn), indium (In), germanium (Ge), silver (Ag), platinum (Pt), gold (Au), lithium (Li), or alloys thereof. In some embodiments, the positive electrode current collector 310 may be formed from one or more carbon containing materials such as carbon fiber, graphite, graphene, carbon black, conductive carbon, amorphous carbon, VGCF, and carbon nanotubes. Similarly, the negative electrode current collector 350 may be formed from materials including, but not limited to, aluminum (AI), nickel (Ni), titanium (Ti), stainless steel, magnesium (Mg), iron (Fe), zinc (Zn), indium (In), germanium (Ge), silver (Ag), platinum (Pt), gold (Au), lithium (Li), or alloys thereof. In some embodiments, the negative electrode current collector 350 may be formed from one or more carbon containing materials such as carbon fiber, graphite, graphene, carbon black, conductive carbon, amorphous carbon, VGCF, and carbon nanotubes.

The separator 330 may include a solid electrolyte material and a binder. The solid electrolyte material may include any solid electrolyte material described herein.

The binder may include any binder described hereinabove. The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The separator 330 may further include a secondary solid electrolyte material. The secondary solid electrolyte material may be any secondary solid electrolyte material discussed hereinabove.

The negative electrode active material composite 340 includes an anode active material. The anode active material preferably is an inorganic material. The anode active material may include one or more inorganic materials such as lithium (Li), lithium alloys, silicon (Si), silicon alloys, tin (Sₙ), tin alloys, germanium (Ge), germanium alloys, carbon, graphite, Li₄Ti₅O₁₂ (LTO), other known anode active materials, or any combination thereof.

The negative electrode active material composite 340 may further include a solid electrolyte material. The solid electrolyte material may include any solid electrolyte material described herein, including a multi-layer surface-modified solid electrolyte material.

The negative electrode active material composite 340 may further include a binder. The binder may be any binder described hereinabove. The binder may comprise a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The negative electrode active material composite 340 may further include a conductive additive. The conductive additive may be any conductive additive discussed hereinabove.

The negative electrode active material composite 340 may further include a secondary solid electrolyte material. The secondary solid electrolyte material may be any secondary solid electrolyte material discussed hereinabove.

### EXAMPLES

### Example 1

### Coating the Cathode Active Material

0.455 g of lithium was added to 30 ml of ethanol to form a solution of lithium ethoxide dissolved in ethanol. To this solution, 1.2 ml of water was added to form a solution of LiOH and ethanol. To this solution, 30 g of NMC powder was added and 0.15 g of a dispersant material. The NMC was mixed in the LiOH containing solution for 2 hours at room temperature and 650 mbar vacuum. After the mixing was complete, the mixture was dried to remove the ethanol, thereby forming a coated cathode active material. The drying process was conducted at 60° C. and a 400 mbar vacuum for about 12 hours. The surface area of this coated cathode active material was approximately 1.6 m²/g as measured by BET.

### Forming the Cathode Composite

The LiOH coated cathode active material was mixed with a carbon additive, a binder, and a sulfide based solid electrolyte material. These materials were mixed to form a homogeneous cathode composite.

### Forming an Electrochemical Cell

The cathode composite was used to form a cathode layer, a sulfide solid state electrolyte was used to form a separator, and lithium metal was used as the anode layer. These layers were assembled such that the cathode layer was in contact with a cathode current collector and in contact with the separator layer. The separate layer was assembled such that it was contacting the cathode layer and the anode layer. The anode layer was assembled such that it contacted the separator layer and the anode current collector.

### Testing the Electrochemical Cell

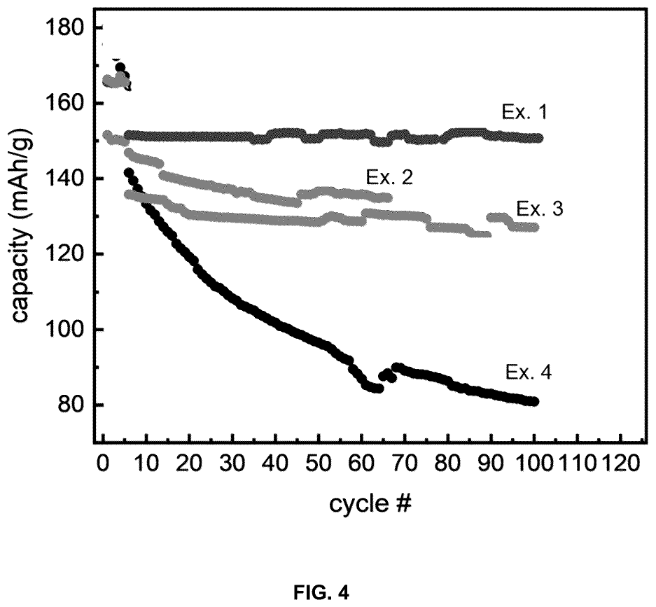

The electrochemical cell was charged using an upper cut off voltage of 4.4 V and was fully charged and discharged where the capacity (mAh/g) of each cycle was tracked and plotted in FIG. 4.

### Example 2

The cathode active material of Example 2 was coated in the same fashion as in Example 1, except the dried coated cathode material was further heated to a temperature of 450° C. in an atmosphere of argon for 3 hours. The surface area of this cathode active material was approximately 0.3 m²/g as measured by BET.

The cell assembly and testing of Example 2 was identical to that of Example 1.

### Example 3

The cathode active material of Example 3 was coated in the same fashion as in Example 1, except, the mixing of the NMC in the LiOH solution was shorter and a higher vacuum (400 mbar) was used during the drying of the coated cathode material. The surface area of this cathode active material was approximately 1.6 m²/g as measured by BET.

The cell assembly and testing of Example 3 was identical to that of Example 1.

### Example 4 (Comparative Example)

The cathode active material of Example 4 is an uncoated version of that used in Examples 1-3, i.e., uncoated NMC. The cell assembly and testing of Example 4 was identical to that of Example 1. The surface area of this cathode active material was approximately 0.5 m²/g as measured by BET.

### Results

The surface area of the material prepared in Example 1 was about 1.1 m²/g higher as compared to the material prepared in Example 4. The surface area of the material prepared in Example 2 was about 0.2 m²/g lower as compared to the material prepared in Example 4.

Comparing the cell cycling data of Example 1 to that of Example 4, shown in FIG. 4, it is shown that the capacity retention can be increased by using a cathode active material with a coating described herein.

FIG. 5A shows a scanning electron microscope (SEM) image of a cross section of a cathode active material particle coated using the process outlined in Example 1. As shown, the cathode active material particle (light grey) is in contact with the coating (dark gray). The coated layer from Example 1 shows a plate-like morphology that produced a porous network that may be more porous at the cathode active material interface and less porous towards the area of the coating layer that contacts the atmosphere, i.e., the outmost surface of the coating layer.

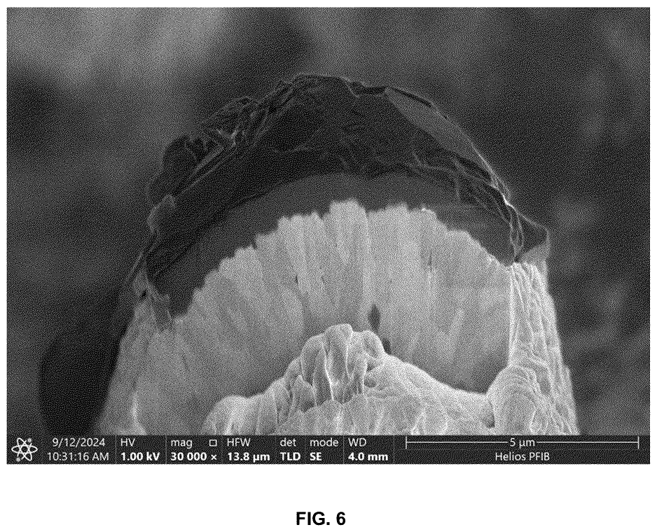

FIG. 6 shows a scanning electron microscope (SEM) image of a cross section of a cathode active material particle coated using the process outlined in Example 2. As shown, the cathode active material particle (light grey) is in contact with the coating (dark gray). However, the coated layer from Example 2 has very little to no porosity.

What is claimed is:

1. A coated cathode active material comprising:
a cathode active material having a surface; and
a coating layer disposed on the surface of the cathode active material, wherein the surface layer comprises a hydroxide material.

2. The coated cathode active material of claim 1, wherein the cathode active material comprises nickel, manganese, cobalt, aluminum, oxygen, lithium, or a combination thereof.

3. The coated cathode active material of claim 1, where the cathode active material comprises a NMC material represented by the formula Li(NiₐCo_{b}Mn_{c})O₂, wherein 0<a<1, 0<b<1, 0<c<1, and a+b+c=1.

4. The coated cathode active material of claim 1, where the cathode active material comprises: LiCoO₂; LiNiO₂; LiMnO₂; LiMn₂O₄; LiNi_{1-Y}Co_{Y}O₂; LiCo_{1-Y}Mn_{Y}O₂; LiNi_{1-Y}Mn_{Y}O₂, wherein 0≤Y<1; Li(NiₐCo_{b}Mn_{c})O₄, wherein 0<a<2, 0<b<2, 0<c<2, and a+b+c=2; LiMn_{2-Z}Ni_{Z}O₄; LiMn_{2-Z}Co_{Z}O₄, wherein 0<Z<2; LiCoPO₄; Li(NiₐCo_{b}Al_{c})O₂, wherein 0<a<1, 0<b<1, 0<c<1, and a+b+c=1; or any combination thereof.

5. The coated cathode active material of claim 1, wherein the hydroxide material comprises one or more of LiOH, NaOH, KOH, Ca(OH)₂, or Mg(OH)₂.

6. The coated cathode active material of claim 1, wherein the coating layer has plate-like morphology.

7. The coated cathode active material of claim 6, wherein the plate-like morphology is defined by plate structures have a width from about 25 nm to about 500 nm.

8. The coated cathode active material of claim 6, wherein the coating layer comprises a hydroxide material having a plate-like morphology where the plates have a thickness from about 5 nm to about 100 nm.

9. The coated cathode active material of claim 1, wherein the coating layer has a porosity from about 1% to about 20%.

10. The coated cathode active material of claim 1, wherein the coating layer has a thickness from about 100 nm to about 2 μm.

11. The coated cathode active material of claim 1, wherein about 5% to about 50% of the surface of the cathode active material is covered by the coating layer.

12. The coated cathode active material of claim 1, wherein the cathode active material comprises a native coating comprising Li, Zr, Al, Nb, Ti, carbon, or any combination thereof.

13. The coated cathode active material of claim 12, wherein the native coating comprises Al₂O₃, ZrO₂, TiO₂, Nb₂O₅, LiNbO₃, LiAlO₂, Li₂ZrO₃, or any combination thereof.

14. The coated cathode active material of claim 12, wherein the native coating has a thickness from about 50 nm to about 5 μm.

15. The coated cathode active material of claim 12, wherein the entire surface of the cathode active material particle is covered by the native coating, such that the first coating is interposed between the surface of the cathode active material and the coating layer.

16. An electrochemical cell comprising:
a cathode current collector, a cathode layer, a separator layer, an anode layer, and an anode current collector,
wherein the cathode layer comprises the coated cathode active material of claim 1.

17. The electrochemical cell of claim 16, wherein the cathode active material comprises Li(NiₐCo_{b}Mn_{c})O₂, wherein 0<a<1, 0<b<1, 0<c<1, and a+b+c=1.

18. The electrochemical cell of claim 16, wherein the separator layer comprises a sulfide solid electrolyte material.

19. The electrochemical cell of claim 18, wherein the sulfide solid electrolyte material comprises an argyrodite material.

20. The electrochemical cell of claim 16, wherein the anode layer comprises Li, Li alloy, Si, Si alloy, carbon, or any combination thereof.

21. A method of making a coated cathode active material comprising:
combining a metal compound and a solvent to form a solution;
adding a cathode active material to the solution to form a mixture;
removing the solvent to produce the coated cathode active material.

22. The method of claim 21, wherein the metal compound comprises Li, Na, K, Ca, or Mg.

23. The method of claim 21, wherein the solvent comprises an alcohol.

24. The method of claim 21, wherein the cathode active material comprises Li(NiₐCo_{b}Mn_{c})O₂, wherein 0<a<1, 0<b<1, 0<c<1, and a+b+c=1.

25. The method of claim 21, further comprising adding a hydrogen-containing compound to the mixture prior to removing the solvent.

26. The method of claim 25, wherein the hydrogen-containing compound comprises H₂O or H₂O₂.

27. The method of claim 21, wherein a ratio of the hydrogen-containing compound to the metal compound is from 1:10 to 1:100.

28. The method of claim 21, further comprising heat treating the coated cathode active material.

29. The method of claim 21, wherein the metal compound comprises a metal hydroxide.

30. The method of claim 21, wherein the metal compound comprises lithium hydroxide.
